(19) United States
(12) Patent Application Publication
(10) Pub. No.: US 2026/0217960 A1
(43) Pub. Date: Jul. 30, 2026

(54) RUBBER COMPOSITION AND HOSE

(71) Applicant: THE YOKOHAMA RUBBER CO., LTD., HIRATSUKA-SHI, KANAGAWA (JP)

(72) Inventors: Aya SATO, HIRATSUKA-SHI, KANAGAWA (JP); Atsushi KIKKAWA, HIRATSUKA-SHI, KANAGAWA (JP); Kaoru TAKAYAMA, HIRATSUKA-SHI, KANAGAWA (JP); Akira ONO, HIRATSUKA-SHI, KANAGAWA (JP)

(21) Appl. No.: 19/135,500

(22) PCT Filed: Oct. 11, 2023
(86) PCT No.: PCT/JP2023/036851

§ 371 Date: Jun. 4, 2025

(30) Foreign Application Priority Data
Dec. 27, 2022 (JP) 2022-210214

(51) Int. Cl. C08L 23/16; C08K 3/22; F16L 11/08

(52) U.S. Cl. CPC C08L 23/16; C08K 3/22; F16L 11/085; C08K 2003/222; C08K 2201/006; C08L 2312/00

(57) ABSTRACT

An object of the present invention is to provide a rubber composition that is excellent in extrudability, adhesiveness to a reinforcing material, and weather resistance. The present invention is a rubber composition including a rubber component containing 80 mass % or more of an ethylene-propylene-ethylidene norbornene copolymer satisfying Formula (I), magnesium oxide, carbon black, and a vulcanizing agent, and a hose formed by using the rubber composition. 3.5≥EE/(EP×ENB×Mn)×10⁶≥0.7 (I). In Formula (I), EE is the content (mol %) of an ethylene-ethylene chain structure, EP is the content (mol %) of an ethylene-propylene chain structure, ENB is the content (mass %) of ethylidene norbornene, and Mn is the number average molecular weight of the ethylene-propylene-ethylidene norbornene copolymer.

### TECHNICAL FIELD

The present invention relates to a rubber composition and a hose.

### BACKGROUND ART

In the related art, a rubber composition containing an ethylene-propylene-non-conjugated diene copolymer or the like has been proposed.

For example, Patent Literature 1 describes a rubber composition obtained by mixing a rubber component containing 50 to 100 mass % of an ethylene-propylene-diene copolymer rubber and a magnesium oxide blend, in which the magnesium oxide blend is a mixture of magnesium oxide having a specific surface area measured by the BET method of 130 m²/g or more, a lubricant, and an oil, the contents of the magnesium oxide, lubricant, and oil in the magnesium oxide blend are 50 to 90 mass %, 5 to 40 mass %, and 5 to 40 mass %, respectively, and the content of the magnesium oxide is 2 to 20 parts by mass per 100 parts by mass of the rubber component.

### CITATION LIST

### Patent Literature

Patent Literature 1: JP 2009-46636 A

### SUMMARY OF INVENTION

### Technical Problem

When a rubber composition containing an ethylene-propylene-non-conjugated diene copolymer or the like is used for production of, for example, a hose, the rubber composition is required to be excellent in extrudability, adhesiveness to a reinforcing material, weather resistance, and the like.

In such circumstances, the present inventors prepared and evaluated a rubber composition with reference to Patent Literature 1 and found that the adhesive strength of the rubber composition to a reinforcing material may be lower than a currently required level.

Thus, an object of the present invention is to provide a rubber composition that is excellent in extrudability, adhesiveness to a reinforcing material, and weather resistance.

Another object of the present invention is to provide a hose.

### Solution to Problem

As a result of intensive studies to solve the issues described above, the present inventors have found that a rubber composition containing a rubber component having a predetermined amount of a specific ethylene-propylene-ethylidene norbornene copolymer, magnesium oxide, carbon black, and a vulcanizing agent can achieve desired effects, and thus have completed the present invention.

An embodiment of the present invention is based on the findings described above, and to be more specific, it is to solve the issues described above by the following configurations.

[1]A rubber composition including: a rubber component containing 80 mass % or more of an ethylene-propylene-ethylidene norbornene copolymer satisfying Formula (I) described below; magnesium oxide; carbon black; and a vulcanizing agent.

[2] The rubber composition according to [1], in which EE/(EP×ENB×Mn)×10⁶ in Formula (I) described below is 1.0 or more and 3.5 or less.

[3] The rubber composition according to [1] or [2], in which a content of the magnesium oxide is 1 part by mass or more and less than 10 parts by mass per 100 parts by mass of the rubber component.

[4] The rubber composition according to any one of [1] to [3], in which the entire rubber component is the ethylene-propylene-ethylidene norbornene copolymer.

[5] The rubber composition according to any one of [1] to [4], in which the magnesium oxide has a BET specific surface area of 100 m²/g or more.

[6] The rubber composition according to any one of [1] to [4], in which the magnesium oxide has a BET specific surface area of less than 100 m²/g.

[7] The rubber composition according to any one of [1] to [6], which is for a hose.

[8]A hose formed by using the rubber composition according to any one of [1] to [6].

[9] The hose according to [8], including an outermost layer formed by using the rubber composition.

### Advantageous Effects of Invention

The rubber composition of the present invention is excellent in extrudability, adhesiveness to a reinforcing material, and weather resistance.

The present invention can also provide a hose.

### BRIEF DESCRIPTION OF DRAWINGS

FIG. 1 is a schematic perspective view illustrating an example of a hose according to an embodiment of the present invention with each layer being cut out.

### DESCRIPTION OF EMBODIMENTS

Embodiments of the present invention will be described in detail below.

In the present specification, a numerical range represented by using “(from) . . . to . . . ” includes the number before “to” and the number after “to”.

In the present specification, unless otherwise noted, a substance corresponding to each component can be used alone or two or more types of substances can be used in combination. In a case where a component contains two or more types of substances, the content of the component means the total content of the two or more types of substances.

Each component used in an embodiment of the present invention is not particularly limited as to the manufacturing method thereof. Examples of the method include a known method.

In the present specification, the case where at least one of extrudability, adhesiveness to a reinforcing material, and weather resistance is excellent may be referred to as “the effect of the present invention is more excellent”.

### [Rubber Composition]

The rubber composition of the present invention is a rubber composition including a rubber component containing 80 mass % or more of an ethylene-propylene-ethylidene norbornene copolymer satisfying the following Formula (I), magnesium oxide, carbon black, and a vulcanizing agent.

$$3.5 \geq EE / ( EP \times ENB \times Mn ) \times {10}^{6} \geq 0.7 \qquad ( I )$$

In Formula (I),
EE is the content (mol %) of an ethylene-ethylene chain structure in the ethylene-propylene-ethylidene norbornene copolymer,
EP is the content (mol %) of an ethylene-propylene chain structure in the ethylene-propylene-ethylidene norbornene copolymer,
ENB is the content (mass %) of ethylidene norbornene in the ethylene-propylene-ethylidene norbornene copolymer, and
Mn is the number average molecular weight of the ethylene-propylene-ethylidene norbornene copolymer.

In the present specification, the ethylene-propylene-ethylidene norbornene copolymer satisfying Formula (I) may be referred to as “specific EPDM”.

In addition, the specific EPDM and ethylene-propylene-non-conjugated diene copolymers other than the specific EPDM may be collectively referred to as “EPDM”.

The EPDM is a copolymer including a constitutional unit derived from ethylene, a constitutional unit derived from propylene, and a constitutional unit derived from a non-conjugated diene.

The rubber composition according to an embodiment of the present invention is thought to achieve desired effects as a result of having such a configuration. Although the reason is not clear, it is assumed to be as follows.

That is, in the present invention, it is presumed that the ethylene-propylene-ethylidene norbornene copolymer (specific EPDM) satisfying Formula (I) improves the dispersibility of a compounding agent in the rubber composition, particularly the dispersion of magnesium oxide, and thus the rubber composition according to an embodiment of the present invention is excellent in extrudability, adhesiveness to a reinforcing material, and weather resistance.

Each of the components contained in the rubber composition according to an embodiment of the present invention will be described in detail below.

### [Rubber Component]

In the rubber composition according to an embodiment of the present invention, the rubber component contains 80 mass % or more of the ethylene-propylene-ethylidene norbornene copolymer (specific EPDM) satisfying Formula (I).

The rubber composition according to an embodiment of the present invention contains the specific EPDM in a predetermined amount, and thus excellent effects of the present invention are obtained.

### [Ethylene-Propylene-Ethylidene Norbornene Copolymer Satisfying Formula (I)]

In the rubber composition according to an embodiment of the present invention, the specific EPDM is an ethylene-propylene-ethylidene norbornene copolymer satisfying Formula (I).

The specific EPDM is a copolymer including a constitutional unit derived from ethylene, a constitutional unit derived from propylene, and a constitutional unit derived from ethylidene norbornene as a non-conjugated diene (third component).

One preferred embodiment of the specific EPDM is a terpolymer of ethylene, propylene, and ethylidene norbornene.

Ethylene and propylene constituting the specific EPDM are not particularly limited.

Examples of the ethylidene norbornene constituting the specific EPDM include 5-ethylidene-2-norbornene.

### [Formula (I)]

In the rubber composition according to an embodiment of the present invention, the specific EPDM satisfies the following Formula (I).

$$3.5 \geq EE / ( EP \times ENB \times Mn ) \times {10}^{6} \geq 0.7 \qquad ( I )$$

In Formula (I),
EE is the content (mol %) of an ethylene-ethylene chain structure in the ethylene-propylene-ethylidene norbornene copolymer,
EP is the content (mol %) of an ethylene-propylene chain structure in the ethylene-propylene-ethylidene norbornene copolymer,
ENB is the content (mass %) of ethylidene norbornene in the ethylene-propylene-ethylidene norbornene copolymer, and
Mn is the number average molecular weight of the ethylene-propylene-ethylidene norbornene copolymer.

In general, a unit of two consecutive monomers in a polymer is referred to as diad.

Examples of the diad that can be possessed by the EPDM include an ethylene-ethylene chain structure, an ethylene-propylene chain structure, and a propylene-propylene chain structure.

The specific EPDM has at least an ethylene-ethylene chain structure and an ethylene-propylene chain structure.

The ethylene-ethylene chain structure is a structure (unit) including two continuous repeating units of ethylene in the EPDM.

The ethylene-propylene chain structure means a structure (unit) in which one repeating unit of ethylene and one repeating unit of propylene are continuous in the EPDM.

EE/(EP×ENB×Mn)×10⁶ in Formula (I) is preferably 1.0 or more and 3.5 or less, more preferably 1.0 or more and 2.0 or less, and further preferably from 1.3 to 1.8, from the viewpoint that the effect of the present invention is more excellent.

### [EE]

In Formula (I), EE is the content (mol %) of the ethylene-ethylene chain structure in the ethylene-propylene-ethylidene norbornene copolymer. EE in Formula (I) is the same value as “EE amount*” calculated in “Calculation of EE amount and the like of specific EPDM” described below. In the present specification, EE in Formula (I) may be referred to as “EE amount”.

### [EP]

In Formula (I), EP is the content (mol %) of the ethylene-propylene chain structure in the ethylene-propylene-ethylidene norbornene copolymer. EP in Formula (I) is the same value as “EP amount**” calculated in “Calculation of EE amount and the like of specific EPDM)” described below. In the present specification, EP in Formula (I) may be referred to as “EP amount”.

### (Propylene-Propylene Chain Structure)

The specific EPDM may further have a propylene-propylene chain structure.

The propylene-propylene chain structure means a structure (unit) including two continuous repeating units of propylene in the EPDM.

In the present specification, the content (mol %) of the propylene-propylene chain structure in the ethylene-propylene-ethylidene norbornene copolymer is also referred to as “PP”.

PP that can be possessed by the specific EPDM is the same value as “PP amount***” calculated in “Calculation of EE amount and the like of specific EPDM)” described below. In the present specification, PP may be referred to as “PP amount”.

EE of the specific EPDM is not particularly limited, as long as the specific EPDM satisfies Formula (I), but from the viewpoint that the effect of the present invention is more excellent, EE is preferably 30.0 to 55.0 mol %, and more preferably 35.0 to 45.0 mol %.

EP of the specific EPDM is not particularly limited, as long as the specific EPDM satisfies Formula (I), but from the viewpoint that the effect of the present invention is more excellent, EP is preferably 40.0 to 65.0 mol %, and more preferably 50.0 to 60.0 mol %.

PP of the specific EPDM is preferably 5.0 to 30.0 mol %, and more preferably 5.0 to 15.0 mol %, from the viewpoint that the effect of the present invention is more excellent.

### (Total of EE, EP, and Above PP in Formula (I))

The total of EE in Formula (I), EP in Formula (I), and above PP (i.e., the total of EE amount*, EP amount**, and PP amount***) is 100 mol %.

### [ENB]

In Formula (I), ENB is the content (mass %) of ethylidene norbornene in the ethylene-propylene-ethylidene norbornene copolymer.

In the present invention, ENB in Formula (I) means the content of a constitutional unit derived from ethylidene norbornene in the specific EPDM. In the present specification, the content of the constitutional unit derived from ethylidene norbornene in the ethylene-propylene-ethylidene norbornene copolymer is also referred to as “ENB amount”.

The ENB amount of the specific EPDM is not particularly limited as long as the specific EPDM satisfies Formula (I), but from the viewpoint that the effect of the present invention is more excellent, the ENB amount is preferably 6.0 to 12.0 mass %, and more preferably 7.0 to 9.5 mass % in the specific EPDM.

### [Mn]

In Formula (I), Mn is the number average molecular weight of the ethylene-propylene-ethylidene norbornene copolymer.

The weight average molecular weight (Mn) of the specific EPDM is not particularly limited as long as the specific EPDM satisfies Formula (I), but from the viewpoint that the effect of the present invention is more excellent, Mn is preferably 10000 to 200000, more preferably 30000 to 100000, and further preferably 40000 to 70000.

### (Calculation of ENB Amount, EE Amount, and the Like of Specific EPDM)

In the present invention, the ENB amount, EE amount, EP amount, and PP amount of the EPDM can be measured, quantified, and calculated by a nuclear magnetic resonance method using isotopic carbon (¹³C-NMR method) in the following manner.

### (Analysis by ¹³C-NMR)

Under the condition of 2048 times of accumulation (2 hours), ¹³C-NMR was measured by an inverse gated decoupling method.

As a sample for ¹³C-NMR measurement, a sample obtained by adding deuterochloroform to EPDM (before vulcanization) to swell it was used.

For chemical shift, the ¹³C signal of deuterochloroform was set at 77 ppm, and this was used as a reference for the chemical shifts of other ¹³C signals.

### (Calculation of ENB Amount of Specific EPDM)

From the total of integrated values (based on mass ratio) of all peaks in an integration range from 51 ppm to 19 ppm of ¹³C-NMR and an integrated value (based on mass ratio) of a peak in an integration range from 42.00 ppm to 40.60 ppm of ¹³C-NMR, the ENB amount (diene amount) of the EPDM was calculated by the following Formula.

$$ENB amount ( mass \% ) = A / B \times 100$$

A: an integrated value (based on mass ratio) of a peak in an integration range of from 42.00 ppm to 40.60 ppm
B: the total of integrated values (based on mass ratio) of all peaks in an integration range of 51 ppm to 19 ppm

The ENB amount obtained as described above can be substituted into “ENB” in Formula (I).

### (Calculation of EE Amount and the Like of Specific EPDM)

In ¹³C-NMR, integration of a peak area was performed in each integration range (ppm) indicated below, and the EE* amount, EP** amount, and PP*** amount were determined by the following Formula using each of the obtained integrated values. Each of the integrated values used in the calculation of the EE* amount and the like is based on a molar ratio with respect to the total integrated value of all chemical shifts included in a region from 19 to 51 ppm (provided that the integrated value of a peak attributed to a structure derived from a conjugated diene (e.g., derived from ENB) is excluded from the total integrated value).

$$EE {amount}^{*} ( mol \% ) = ( 9 ) \times 0.5 + 0.25 \times ( 8 ) + ( 11 ) \times 0.5$$

The above (9) represents the integrated value (based on molar ratio) of a peak area in an integration range of from 30.68 to 30.00 ppm.

The above (8) represents the integrated value (based on molar ratio) of a peak area in an integration range of from 31.00 to 30.68 ppm.

The above (11) represents the integrated value (based on molar ratio) of a peak area in an integration range of from 27.80 to 27.43 ppm.

$$EP a m o u n {t}^{* *} ( mol \% ) = ( 2 )$$

The above (2) represents the integrated value (based on molar ratio) of a peak area in an integration range of from 39.80 to 35.60 ppm.

$$PP a m o u n {t}^{* * *} ( mol \% ) = ( 1 ) + ( E 1 ) - 4 \times ( E 2 )$$

The above (1) represents the integrated value (based on molar ratio) of a peak area in an integration range of from 49.00 to 42.00 ppm.

The above (E1) represents the integrated value (based on molar ratio) of a peak area in an integration range of from 51.00 to 49.00 ppm.

The above (E2) represents the integrated value (based on molar ratio) of a peak area in an integration range of from 42.00 to 40.60 ppm.

Symbols (E1) to (11) representing the integrated values of the peak areas in the respective integration ranges, attributions in the respective integration ranges, and the respective integration ranges (ppm) are collectively listed below.

### Symbol: Attribution: Integration Range (Ppm)

(E1): ENB (C1E): from 51.00 to 49.00 ppm
(1): Sαα+ENB (C5+C6+C1Z): from 49.00 to 42.00 ppm
(E2): ENB (C4): from 42.00 to 40.60 ppm
(2): Sαγ+Sαδ: from 39.80 to 35.60 ppm
(8): Sγδ: from 31.00 to 30.68 ppm
(9): Sδδ: from 30.68 to 30.00 ppm
(11): Sβγ: from 27.80 to 27.43 ppm

ENB of the above (E1) and (E2) is 5-ethylidene-2-norbornene.

In the above attributions, S means methylene. The Greek letter indicates the position of a methylene carbon atom on the main chain between shortest two carbon atoms to which a methyl group is bonded in the EPDM, and a carbon atom next to the carbon atom to which the methyl group is bonded is defined as α. Examples of carbon notations are listed below.

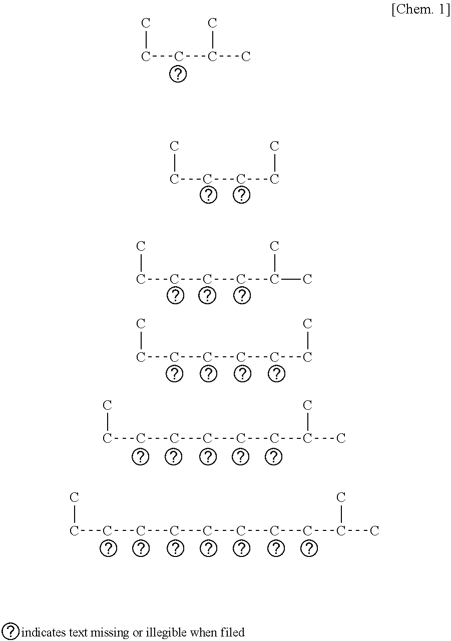

For the attributions of the EPDM and calculation of monomer ratio, diad ratio, and the like, for example, the following documents can be referred to.
1. Monomer Composition and Sequence Structure Analysis (NMR) of Ethylene-Propylene Elastomer (EPDM), Tosoh Technical Report: No. T1913/2019.12.4
2. Determination of Monomer Sequence Distribution in EPDM by 13C-NMR: Third Monomer Effects [Journal of Applied Polymer Science, Vol. 71, 523-530 (1999)]
3. U.S. Pat. No. 9,543,596 B2

### Method for Measuring Number Average Molecular Weight of Specific EPDM

In the present specification, the number average molecular weight of the EPDM (specific EPDM) is the value in terms of standard polystyrene based on the value as measured by gel permeation chromatography (GPC).

Measurement conditions for the number average molecular weight of the specific EPDM are as follows.
Measurement instrument: HLC-8020 (available from Tosoh Corporation)
Column: GMH-HR-H (available from Tosoh Corporation), two columns connected in series
Detector: Differential refractometer RI-8020 (available from Tosoh Corporation)
Eluent: Tetrahydrofuran
Column temperature: 40° C.

The number average molecular weight of the EPDM (specific EPDM) can be substituted into “Mn” in Formula (I).

### [Content of Specific EPDM]

In the rubber composition according to an embodiment of the present invention, the content of the specific EPDM is 80 mass % or more in the rubber component.

When the content of the specific EPDM is 80 mass % or more in the rubber component, excellent effect (particularly, weather resistance) of the present invention is achieved.

From the viewpoint of achieving more excellent effect of the present invention, the rubber component preferably contains the specific EPDM in an amount of 90 to 100 mass % in the rubber component, and the entire rubber component is more preferably the specific EPDM.

### (Additional Rubber Component)

When the rubber component further contains a rubber component (additional rubber component) other than the specific EPDM, the additional rubber component is not particularly limited. Examples of the additional rubber component include diene rubbers, and more specific examples thereof include natural rubber; butadiene rubber; and aromatic vinyl-diene copolymers such as styrene-butadiene rubber.

In a case where the rubber component further contains an additional rubber component, the additional rubber component preferably includes a styrene-butadiene rubber (SBR) from the viewpoint of achieving more excellent effect (particularly, ozone resistance) of the present invention.

The content of the additional rubber component is preferably from 0 to 20 mass %, more preferably from 0 to 10 mass %, and still more preferably 0 mass % in the rubber component, from the viewpoint that the effect of the present invention is more excellent.

### [Magnesium Oxide]

The rubber composition according to an embodiment of the present invention contains magnesium oxide.

For the magnesium oxide contained in the rubber composition according to an embodiment of the present invention, from the viewpoint that the effect of the present invention (particularly, adhesiveness to a reinforcing material, more particularly, adhesiveness to a fiber reinforcing material) is more excellent, the BET specific surface area of the magnesium oxide is preferably 100 m²/g or more, and the BET specific surface area of the magnesium oxide is more preferably 120 to 200 m²/g.

For the magnesium oxide contained in the rubber composition of the present invention, from the viewpoint that the effect of the present invention (particularly, extrudability) is more excellent, the BET specific surface area of the magnesium oxide is preferably less than 100 m²/g, and the BET specific surface area of the magnesium oxide is more preferably 10 to 50 m²/g.

In the present invention, the BET specific surface area is a specific surface area of a sample powder obtained from the amount of adsorption of molecules (typically, N₂ gas) having a known occupied area on the surfaces of particles of the powder.

### (Content of Magnesium Oxide)

From the viewpoint that the effect of the present invention is more excellent, the content of the magnesium oxide is preferably 1 part by mass or more and less than 10 parts by mass, and more preferably 3 parts by mass or more and 8 parts by mass or less, per 100 parts by mass of the rubber component.

### [Carbon Black]

The rubber composition according to an embodiment of the present invention contains carbon black.

### (Iodine Adsorption Amount)

The iodine adsorption amount of the carbon black contained in the rubber composition according to an embodiment of the present invention is preferably 20 to 50 mg/g and more preferably 20 to 40 mg/g, from the viewpoint that the effect of the present invention is more excellent.

The iodine adsorption amount of the carbon black can be measured in accordance with JIS K 6217-1:2008.

### (Nitrogen Adsorption Specific Surface Area)

The nitrogen adsorption specific surface area (N₂ SA) of the carbon black is preferably 5 to 50 m²/g and more preferably 20 to 40 m²/g, from the viewpoint that the effect of the present invention is more excellent.

The nitrogen adsorption specific surface area of the carbon black can be measured in accordance with JIS K6217-2:2008.

### (Dibutyl Phthalate Oil Absorption Amount)

From the viewpoint that the effect of the present invention is more excellent, the dibutyl phthalate (DBP) oil absorption amount of the carbon black is preferably 30 to 130 mL/100 g, and more preferably 50 to 100 mg/g.

The DBP oil absorption amount of the carbon black can be measured in accordance with JIS K6217-4:2008.

### (Type of Carbon Black)

The carbon black preferably contains at least one selected from the group consisting of SAF, ISAF, HAF, FEF, GPF, SRF, FT, and MT carbon black, more preferably contains at least one selected from the group consisting of FEF, GPF, SRF, FT, and MT carbon black, and still more preferably contains FEF and/or SRF carbon black, from the viewpoint of achieving more excellent effect of the present invention.

### (Content of Carbon Black)

The content of the carbon black is preferably 70 parts by mass or more, and more preferably 70 to 150 parts by mass per 100 parts by mass of the rubber component, from the viewpoint that the effect of the present invention is more excellent.

### [Vulcanizing Agent]

The rubber composition according to an embodiment of the present invention contains a vulcanizing agent. The vulcanizing agent is, for example, sulfur or a peroxide.

In one preferred embodiment, the vulcanizing agent contained in the rubber composition of the present invention includes sulfur.

Sulfur is not particularly limited, as long as it can be used for vulcanization of a rubber. Examples of the sulfur include known sulfur.

The form of sulfur is not particularly limited. Examples of the form of sulfur include oil-treated sulfur and powdery sulfur.

### (Content of Vulcanizing Agent)

The content of the vulcanizing agent (when the vulcanizing agent contains sulfur, the content of sulfur refers to a net content of sulfur) is preferably 0.65 parts by mass or more, and more preferably 0.70 to 3.0 parts by mass per 100 parts by mass of the rubber component, from the viewpoint that the effect of the present invention is more excellent.

### (Additive)

The rubber composition according to an embodiment of the present invention may further contain an additive, as necessary, as long as the effect of the present invention is not impaired.

Examples of the additive include softening agents such as paraffin oil; talc, silica; vulcanization accelerator aids (e.g., stearic acid), zinc oxide, vulcanization retarders, vulcanization accelerators, and anti-aging agents.

When the rubber composition according to an embodiment of the present invention further contains talc, talc is not particularly limited. Examples thereof include typically known talc.

When the rubber composition according to an embodiment of the present invention further contains talc, the content of talc can be, for example, 10 to 100 parts by mass per 100 parts by mass of the rubber component.

As one preferred aspect, the rubber composition according to an embodiment of the present invention does not contain an ethylene-propylene copolymer (bipolymer of ethylene and propylene). The ethylene-propylene copolymer does not correspond to the EPDM.

### (Method for Producing Rubber Composition)

The method for producing the rubber composition according to an embodiment of the present invention is not particularly limited. For example, the rubber composition according to an embodiment of the present invention can be produced by mixing the above-described essential components and optional components that can be used if necessary under the condition of 100 to 180° C.

### (Vulcanization of Rubber Composition)

The method for vulcanization (sulfur vulcanization or peroxide vulcanization) of the rubber composition according to an embodiment of the present invention is not particularly limited. The rubber composition according to an embodiment of the present invention can be vulcanized under the condition of from 140 to 190° C., for example. Specific examples of the vulcanization method include press vulcanization, steam vulcanization, oven vulcanization (dry heat vulcanization), and hot water vulcanization. A cured product (vulcanized rubber) can be obtained by vulcanizing the rubber composition according to an embodiment of the present invention.

### (Application)

The rubber composition according to an embodiment of the present invention can be applied to, for example, a hose.

Examples of the hose include a hose for an air conditioner. Specific examples of the hose include a hose for a car air conditioner.

The rubber composition according to an embodiment of the present invention is preferably applied to an outermost layer of the hose.

### [Hose]

The hose according to an embodiment of the present invention is a hose formed by using the rubber composition for the hose according to an embodiment of the present invention.

The hose according to an embodiment of the present invention is not particularly limited, as long as the hose is formed by using the rubber composition according to an embodiment of the present invention. The rubber composition used in the hose according to an embodiment of the present invention is not particularly limited, as long as it is the rubber composition according to an embodiment of the present invention. It is not particularly limited on which member of the hose according to an embodiment of the present invention is formed by the rubber composition according to an embodiment of the present invention.

### (Outermost Layer)

The hose according to an embodiment of the present invention preferably includes an outermost layer formed by the rubber composition according to an embodiment of the present invention.

The thickness of the outermost layer can be, for example, from 0.2 to 4 mm.

In addition to the outermost layer, the hose according to an embodiment of the present invention may further include at least one selected from the group consisting of a reinforcing layer, an innermost layer, and an intermediate rubber layer. The outermost layer may be a single layer or a plurality of layers. The same applies to the innermost layer, the reinforcing layer, and the intermediate rubber layer.

The hose according to an embodiment of the present invention can include, for example, the innermost layer, the reinforcing layer, and the outermost layer in this order.

### (Innermost Layer)

The innermost layer that can be included in the hose according to an embodiment of the present invention is not particularly limited. Examples of the innermost layer include known innermost layers. The composition used for forming the innermost layer may be, for example, any of a rubber composition and a resin composition.

The thickness of the innermost layer can be, for example, from 0.2 to 4 mm.

### (Reinforcing Layer)

The reinforcing layer that can be included in the hose according to an embodiment of the present invention is not particularly limited. Examples of the reinforcing layer include known reinforcing layers.

Examples of the reinforcing material constituting the reinforcing layer include a metal reinforcing material and a fiber reinforcing material.

From the viewpoint that the effect of the present invention is more excellent, an example of a preferable aspect is one in which the reinforcing material is a fiber reinforcing material. Examples of the fiber reinforcing material include a reinforcing material for chemical fibers, such as polyamide and polyester. The reinforcing layer may be surface-treated with, for example, resorcinol formaldehyde latex (RFL).

Examples of the form of the reinforcing layer include those braided into a spiral structure and/or a blade structure.

An example of the hose of the present invention will be described with reference to the accompanying drawings. However, the present invention is not limited to the attached drawings.

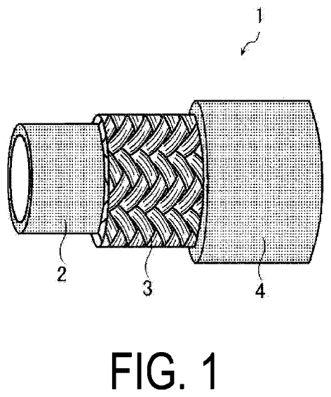

FIG. 1 is a schematic perspective view illustrating an example of a hose of the present invention with each layer being cut out.

In FIG. 1, a hose 1 includes an innermost layer 2, a reinforcing layer 3 on the innermost layer 2, and an outermost layer 4 on the reinforcing layer 3. As one preferred aspect, the outermost layer 4 is formed by the rubber composition according to an embodiment of the present invention. An example of a preferable aspect is one in which the reinforcing material constituting the reinforcing layer 3 is a fiber reinforcing material.

The method for producing the hose according to an embodiment of the present invention is not particularly limited. For example, the hose according to an embodiment of the present invention can be produced by stacking a rubber composition for forming an innermost layer, a fiber reinforcing material for forming a reinforcing layer, and a rubber composition for forming an outermost layer (e.g., the rubber composition according to an embodiment of the present invention) in this order on a mandrel to form a multilayer structure, covering the multilayer structure with a nylon cloth or the like, and vulcanizing and bonding each layer of the multilayer structure covered with the nylon cloth or the like by press vulcanization, steam vulcanization, oven vulcanization (dry heat vulcanization) or hot water vulcanization under the conditions of a temperature from 140 to 190° C. and a period from 30 to 180 minutes.

Examples of the intended use of the hose according to an embodiment of the present invention include a hose for an air conditioner. Specific examples of the intended use include a hose for a car air conditioner.

### Example

The present invention will be described below in detail by way of Examples. However, the present invention is not limited to the Examples.

### <Production of Rubber Composition>

Components shown in Table 1 below and components shown in the common formulation in Table 3 below were used in a composition (parts by mass) shown in the tables and mixed by an agitator, to produce a rubber composition.

Specifically, a master batch was obtained by first mixing the components shown in the following tables, except for oil-treated sulfur and a vulcanization accelerator, in a (1.5-L) Banbury mixer for 5 minutes, and then discharging the mixture when the temperature reached 140° C.

Then, the oil-treated sulfur and the vulcanization accelerator were added to the master batch obtained as described above, and they were mixed using an open roll, to produce a rubber composition.

### (Evaluation of Extrudability)

Extrudability was evaluated by using the rubber composition produced as described above. The results are shown in Table 1 (Tables 1-1 and 1-2. the same applies hereinafter).

The extrudability was evaluated in accordance with ASTM D2230-96 by performing extrusion molding in accordance with the ASTM A method using a Rheomex (registered trademark) 104 type laboratory mixing extrusion tester (available from Haake Technik GmbH) using a so-called Garvey die at a cylinder temperature of 80° C., a die temperature of 80° C., a head temperature of 80° C., and a screw rotational speed of 60 rpm, and evaluating the appearance of an extrudate of the rubber composition obtained above.

The appearance of the extrudate was evaluated by a scoring method B. The scoring method B evaluates the “sharpness and continuity of the 300 edge” of the extrudate on a rank of 10 to 1.

In the present invention, when the rank of “sharpness and continuity of 300 edge” of the extrudate was 7 or more, the extrudability of the rubber composition was evaluated to be excellent. The extrudability is more excellent with the rank larger than 7.

In contrast, when the rank was less than 7, the extrudability was evaluated as poor.

### <Production of Hose>

A hose-shaped test piece having a rubber layer (outermost layer) formed by using the rubber composition produced as described above and a reinforcing layer obtained by dipping polyester fiber A (three strands of 1100 dtex) as a reinforcing material in an RFL treatment liquid was produced as follows.

First, the polyester fiber A was wound in a blade shape on a mandrel having an outer diameter of 34 mm to form a reinforcing layer.

Then, a sheet (thickness 2.5 mm, unvulcanized) of the rubber composition produced as described above was bonded on the reinforcing layer and vulcanized under the condition of 160° C. for 100 minutes to produce a hose-shaped test piece.

For the obtained hose-shaped test piece, the adhesiveness between the rubber layer and the reinforcing material was evaluated by the following method. The results are shown in Table 1.

### <Adhesiveness to Reinforcing Material>

The peel strength (strength required for peeling, unit: N/mm) was measured when the rubber layer was peeled off from the obtained hose-shaped test piece at a peeling speed of 50 mm/min.

In the present invention, when the peel strength was 3.4 N/mm or more, the adhesiveness between the rubber layer and the reinforcing material was evaluated to be excellent. As the peel strength is larger than 3.4 N/mm, the adhesiveness between the rubber layer and the reinforcing material is more excellent.

In contrast, when the peel strength was less than 3.4 N/mm, the adhesiveness between the rubber layer and the reinforcing material was evaluated to be poor.

### <Weather Resistance>

The rubber composition produced as described above was vulcanized for 45 minutes at 153° C. under a surface pressure of 3.0 MPa using a press molding machine, to form a vulcanized sheet having a thickness of 2 mm, and a JIS No. 3 dumbbell-shaped test piece in accordance with JIS K6251: 2017 was cut out from the vulcanized sheet.

Then, the test piece was elongated by 20% and subjected to ozone deterioration for 168 hours under the conditions of an ozone concentration of 100 pphm and 50° C., and then the presence or absence of ozone cracks on the surface of the test piece was visually evaluated.

In the present invention, when there was no crack on the surface of the test piece after ozone deterioration, the weather resistance was evaluated to be excellent, which was indicated as “◯”.

In contrast, when there was crack on the surface of the test piece after ozone deterioration, the weather resistance was evaluated to be poor, which was indicated as “X”.

The results of the weather resistance are shown in Table 1.

TABLE 1

| | | Compar- | | | | Compar- | Compar- | Compar- |
|---|---|---|---|---|---|---|---|---|
| | | ative | | | | ative | ative | ative |
| Table 1-1 | | Example | Example | Example | Example | Example | Example | Example |
| (rubber composition) | | 1 | 1 | 3 | 5 | 2 | 3 | 6 |
| EPDM | KEP650 | 100 | 100 | | | | | |
| | EP65 | | | 100 | | | | |
| | EPT4070 | | | | 100 | | | |
| | NORDEL6565XFC | | | | | 100 | | 100 |
| | Keltan 6950C | | | | | | 100 | |
| | (CHINA) | | | | | | | |
| | Esprene 505 | | | | | | | |
| SBR | NIPOL1502 | | | | | | | |
| EE/(EP × ENB × Mn) × 10⁶ | | 1.4 | 1.4 | 1.2 | 0.9 | 0.6 | 0.4 | 0.6 |
| of EPDM | | | | | | | | |
| SRF Carbon black | | 100 | 100 | 100 | 100 | 100 | 100 | 100 |
| Talc | | 30 | 30 | 30 | 30 | 30 | 30 | 30 |
| Magnesium | MgO30 (BET | 0 | 5 | 5 | 5 | 5 | 5 | 0 |
| oxide | specific surface | | | | | | | |
| | area 30 m²/g) | | | | | | | |
| | MgO150 (BET | 0 | | | | | | 0 |
| | specific surface | | | | | | | |
| | area 150 m²/g) | | | | | | | |

| | | | | | | | |
|---|---|---|---|---|---|---|---|
| Oil-treated sulfur (sulfur | 1.0 | 1.0 | 1.0 | 1.0 | 1.0 | 1.0 | 1.0 |
| concentration 95 mass %) | | | | | | | |
| Extrudability (rank) | 10 | 9 | 8 | 7 | 6 | 2 | 10 |
| Adhesiveness to reinforcing | 1.1 | 3.7 | 3.6 | 3.4 | 3.1 | 3.0 | 0.9 |
| material (peel strength, | | | | | | | |
| unit: N/mm) | | | | | | | |
| Weather Resistance | ∘ | ∘ | ∘ | ∘ | ∘ | ∘ | ∘ |

| | | Compar- | Compar- | | Compar- | Compar- | |
|---|---|---|---|---|---|---|---|
| | | ative | ative | | ative | ative | |
| Table 1-1 | | Example | Example | Example | Example | Example | Example |
| (rubber composition) | | 7 | 9 | 6 | 4 | 5 | 7 |
| EPDM | KEP650 | | | | | | |
| | EP65 | | | 80 | | | 100 |
| | EPT4070 | | | | | | |
| | NORDEL6565XFC | | | | | | |
| | Keltan 6950C | 100 | | | 80 | 60 | |
| | (CHINA) | | | | | | |
| | Esprene 505 | | 100 | | | | |
| SBR | NIPOL1502 | | | 20 | 20 | 40 | |
| EE/(EP × ENB × Mn) × 10⁶ | | 0.4 | 3.8 | 1.2 | 0.4 | 0.4 | 1.2 |
| of EPDM | | | | | | | |
| SRF Carbon black | | 100 | 100 | 100 | 100 | 100 | 100 |
| Talc | | 30 | 30 | 30 | 30 | 30 | 30 |
| Magnesium | MgO30 (BET | 0 | 0 | 5 | 5 | 5 | 2 |
| oxide | specific surface | | | | | | |
| | area 30 m²/g) | | | | | | |
| | MgO150 (BET | 0 | 0 | | | | |
| | specific surface | | | | | | |
| | area 150 m²/g) | | | | | | |

| | | | | | | |
|---|---|---|---|---|---|---|
| Oil-treated sulfur (sulfur | 1.0 | 1.0 | 1.0 | 1.0 | 1.0 | 1.0 |
| concentration 95 mass %) | | | | | | |
| Extrudability (rank) | 10 | 10 | 9 | 5 | 9 | 7 |
| Adhesiveness to reinforcing | 0.8 | 1.1 | 4.1 | 3.5 | 3.7 | 3.5 |
| material (peel strength, | | | | | | |
| unit: N/mm) | | | | | | |
| Weather Resistance | ∘ | ∘ | ∘ | ∘ | x | ∘ |

TABLE 2

| | | Compar- | | | | Compar- | Compar- | | Compar- | |
|---|---|---|---|---|---|---|---|---|---|---|
| | | ative | | | | ative | ative | | ative | |
| Table 1-2 | | Example | Example | Example | Example | Example | Example | Example | Example | Example |
| (rubber composition) | | 8 | 2 | 4 | 9 | 11 | 12 | 8 | 10 | 10 |
| EPDM | KEP650 | | 100 | | | | | 80 | 60 | 100 |
| | EP65 | | | 100 | | | | | | |
| | EPT4070 | | | | 100 | | | | | |
| | NORDEL6565XFC | | | | | 100 | | | | |
| | Keltan 6950C | | | | | | 100 | | | |
| | (CHINA) | | | | | | | | | |
| | Esprene 505 | 100 | | | | | | | | |
| SBR | NIPOL 1502 | | | | | | | 20 | 40 | |
| EE/(EP × ENB × Mn) × 10⁶ | | 3.8 | 1.4 | 1.2 | 0.9 | 0.6 | 0.4 | 1.4 | 1.4 | 1.4 |
| of EPDM | | | | | | | | | | |
| SRF Carbon black | | 100 | 100 | 100 | 100 | 100 | 100 | 100 | 100 | 100 |
| Talc | | 30 | 30 | 30 | 30 | 30 | 30 | 30 | 30 | 0 |
| Magnesium | MgO30 (BET method | | | | | | | | | |
| oxide | specific surface | | | | | | | | | |
| | area 30 m²/g) | | | | | | | | | |
| | MgO150 (BET method | 5 | 5 | 5 | 5 | 5 | 5 | 5 | 5 | 5 |
| | specific surface | | | | | | | | | |
| | area 150 m²/g) | | | | | | | | | |

| | | | | | | | | | |
|---|---|---|---|---|---|---|---|---|---|
| Oil-treated sulfur (sulfur | 1.0 | 1.0 | 1.0 | 1.0 | 1.0 | 1.0 | 1.0 | 1.0 | 1.0 |
| concentration 95 mass %) | | | | | | | | | |
| Extrudability (rank) | 10 | 8 | 7 | 7 | 5 | 1 | 9 | 10 | 10 |
| Adhesiveness to reinforcing | 3.1 | 4.2 | 4.3 | 3.9 | 3.8 | 3.5 | 4.6 | 4.8 | 4.3 |
| material (peel strength, | | | | | | | | | |
| unit: N/mm) | | | | | | | | | |
| Weather Resistance | ∘ | ∘ | ∘ | ∘ | ∘ | ∘ | ∘ | x | ∘ |

Details of the components shown in Table 1 are as follows.

### (EPDM)

KEP650 (trade name) available from Kumho Polychem Co. Ltd.
EP65 (trade name) available from ENEOS Materials Corporation
EPT4070 (trade name) available from Mitsui Chemicals, Inc.
NORDEL6565XFC (trade name) available from DOW
Keltan 6950C (CHINA) (trade name) available from ARLANXEO
Esprene 505 (trade name) available from Sumitomo Chemical Co., Ltd.

All of the above EPDM is an ethylene-propylene-5-ethylidene-2-norbornene copolymer.

ENB, EP, BE, and Mn of each EPDM for substitution into Formula (1), and the value of EE/(EP×ENB×Mn)×10⁶ are shown in Table 2 below.

TABLE 3

| | | | | | Keltan | |
|---|---|---|---|---|---|---|
| Table 2 | | | | | 6950C | Esprene |
| (EPDM) | KEP650 | EP65 | EPT4070 | NORDEL6565XFC | (CHINA) | 505 |
| ENB (mass %) | 8.2 | 8.0 | 6.6 | 8.6 | 7.9 | 10.0 |
| EP (mol %) | 54 | 55 | 54 | 46 | 56 | 55 |
| EE (mol %) | 40 | 39 | 40 | 40 | 29 | 38 |
| PP (mol %) | 6 | 6 | 6 | 14 | 15 | 7 |
| Mn | 63713 | 73657 | 129137 | 155298 | 167510 | 18151 |
| EE/(EP × | 1.4 | 1.2 | 0.9 | 0.6 | 0.4 | 3.8 |
| ENB × Mn) × 10⁶ | | | | | | |

As shown in Table 2 above, KEP650, EP65, and EPT4070 satisfy Formula (I) described above.

Meanwhile, NORDEL6565XFC, Keltan 6950C (CHINA), and Esprene 505 do not satisfy Formula (I) described above.

### (SBR)

NIPOL1502 (trade name): styrene-butadiene rubber available from ZEON CORPORATION
SRF Carbon black: trade name: Asahi #50, available from Asahi Carbon Co., Ltd.
Talc: trade name MISTRON VAPOR, available from Imerys

### (Magnesium Oxide)

MgO30: Kyowa Mag 30 (trade name) available from Kyowa Chemical Industry Co., Ltd. BET specific surface area 30 m²/g
MgO150: Kyowa Mag 150 (trade name) available from Kyowa Chemical Industry Co., Ltd. BET specific surface area 150 m²/g
Oil-treated sulfur: available from Hosoi Chemical Industry Co., Ltd. The oil-treated sulfur contains sulfur. The concentration of sulfur in the oil-treated sulfur is 95 mass %.

### (Common Formulation)

TABLE 4

| Table 3 (common formulation) | Parts by mass |
|---|---|
| Paraffin oil | 30 |
| Zinc oxide (ZnO) | 5 |
| Stearic acid | 1 |
| Vulcanization accelerator CZ | 2.5 |
| Vulcanization accelerator DM | 2.5 |

Details of the components shown in Table 3 are as follows.
Paraffin oil: trade name: SUNPAR 2280. available from Japan Sun Oil Company, Ltd.
Zinc oxide (ZnO): Zinc Oxide III, available from Seido Chemical Industry Co., Ltd.
Stearic acid: stearic acid beads, available from Nippon Oil & Fats Co., Ltd.
Vulcanization accelerator CM: N-cyclohexyl-2-benzothiazolyl sulfenamide. Sulfenamide-based. Sanceller CM, available from Sanshin Chemical Industry Co., Ltd.
Vulcanization accelerator DM: dibenzothiazyl disulfide. Thiazole-based. Sanceller DM, available from Sanshin Chemical Industry Co., Ltd.

As can be seen from the results shown in Table 1, in Comparative Example 1, in which no magnesium oxide was contained, adhesiveness to the reinforcing material was poor.

In Comparative Examples 2 to 4, 11, and 12, in which EPDM not satisfying Formula (I) was contained, at least extrudability was poor.

In Comparative Example 5, in which the rubber component contained 60 mass % of EPDM not satisfying Formula (I), weather resistance was poor.

In Comparative Examples 6 to 7 and 9, in which EPDM not satisfying Formula (I) was contained, and no magnesium oxide was contained, adhesiveness to the reinforcing material was poor.

In Comparative Example 8, in which EPDM not satisfying Formula (I) was contained, adhesiveness to the reinforcing material was poor.

In Comparative Example 10, in which the rubber component contained 60 mass % of EPDM satisfying Formula (I), weather resistance was poor.

In contrast, the rubber composition according to an embodiment of the present invention was excellent in extrudability, adhesiveness to the reinforcing material, and weather resistance.

### REFERENCE SIGNS LIST

1 Hose
2 Innermost layer
3 Reinforcing layer (reinforcing material)
4 Outermost layer

1. A rubber composition comprising:
a rubber component containing 80 mass % or more of an ethylene-propylene-ethylidene norbornene copolymer satisfying Formula (I);
magnesium oxide;
carbon black; and
a vulcanizing agent,
$$3.5 \geq EE / ( EP \times ENB \times Mn ) \times {10}^{6} \geq 0.7 \qquad ( I )$$
where,
EE is a content (mol %) of an ethylene-ethylene chain structure in the ethylene-propylene-ethylidene norbornene copolymer,
EP is a content (mol %) of an ethylene-propylene chain structure in the ethylene-propylene-ethylidene norbornene copolymer,
ENB is a content (mass %) of ethylidene norbornene in the ethylene-propylene-ethylidene norbornene copolymer, and
Mn is a number average molecular weight of the ethylene-propylene-ethylidene norbornene copolymer.

2. The rubber composition according to claim 1, wherein EE/(EP×ENB×Mn)×10⁶ in Formula (I) is 1.0 or more and 3.5 or less.

3. The rubber composition according to claim 1, wherein a content of the magnesium oxide is 1 part by mass or more and less than 10 parts by mass per 100 parts by mass of the rubber component.

4. The rubber composition according to claim 1, wherein the entire rubber component is the ethylene-propylene-ethylidene norbornene copolymer.

5. The rubber composition according to claim 1, wherein the magnesium oxide has a BET specific surface area of 100 m²/g or more.

6. The rubber composition according to claim 1, wherein the magnesium oxide has a BET specific surface area of less than 100 m²/g.

7. The rubber composition according to claim 1, wherein the rubber composition is for a hose.

8. A hose formed by using the rubber composition according to claim 1.

9. The hose according to claim 8, comprising an outermost layer formed by using the rubber composition.
